(19) United States
(12) Patent Application Publication
(10) Pub. No.: US 2025/0028702 A1
(43) Pub. Date: Jan. 23, 2025

(54) AUGMENTED INTELLIGENCE RELATIONSHIP DISPLAY FOR MANAGING DATA

(71) Applicant: INTERNATIONAL BUSINESS MACHINES CORPORATION, ARMONK, NY (US)

(72) Inventors: Hamid Majdabadi, OTTAWA (CA); Su Liu, Austin, TX (US); NEIL DELIMA, Scarborough (CA); Zhan Peng Huo, Beijing (CN)

(21) Appl. No.: 18/354,237

(22) Filed: Jul. 18, 2023

(51) Int. Cl. G06F 16/22; G06F 3/01; G06F 3/04815; G06F 16/25; G06F 16/27

(52) U.S. Cl. CPC G06F 16/2282; G06F 3/013; G06F 3/04815; G06F 16/2246; G06F 16/258; G06F 16/27

(57) ABSTRACT

A method, computer system, and a computer program product are provided for managing and retrieving data dynamically. A business information (BI) table is created from databases and reports and synchronized with data in a management platform. A user interface having rules and criteria is established for a user access to the BI. The management platform is monitored for updates and BI table is synchronized with it. The updated information is stored in a log file. Using the log file and the management platform, the BI entries are then paired with one or more source data and a retrievable tree is created from the pairing. The BI table is then provided to the user and monitored for viewing. An eye gazing point is located through user's eye so that an associated BI entry and its paired source is retrieved for the user to see subsequently.

### BACKGROUND

The present invention relates generally to the field of data management and more particularly to techniques for providing an augmented reality intelligence system for managing data and displaying dynamic data changes.

Business Intelligence (BI) comprises the strategies and technologies used by enterprises for data management including analysis of data and business information. Data migration, at times in form of content, may be an important feature of BI. This may be because data migration involves a variety of tasks such as embedding, merging, splitting data, and generating customized reports. For instance, in a scenario that includes having a BI dashboard with multiple reports connecting to one or many databases, when migrating a dashboard or any individual reports to a new BI server, users may be required to identify, map or link to migrated content to the data source in a target portal. In addition, any hyperlinks saved in metadata may be used to show the relationship between a specific data entry in BI table and supported resource data.

In such instances, it may be difficult know where the sources of data may be located. There may be no ideal way to view the related supported source data in a specific data entry even in a business information table.

### SUMMARY

Embodiments of the present invention disclose a method, computer system, and a computer program product for managing and retrieving data dynamically. In one embodiment, a business information (BI) table is created from a plurality of databases and reports. This table is synchronized with other data and processes in a management platform. A user interface having rules and criteria is determined for providing a user access to the BI. The management platform is monitored for updates and BI table is synchronized with it so that the updates are provided to the table simultaneously. The updated processes to the BI table are then stored in a log file. Using the log file and the management platform, the BI entries are then paired with one or more source data and a retrievable tree is created from the pairing. The BI table is then provided to the user and monitored for viewing. An eye gazing point is provided as the user views the table and based on the location of the user's eye, a BI entry and an associated paired of relationships is retrieved for the user to see subsequently.

### BRIEF DESCRIPTION OF THE SEVERAL VIEWS OF THE DRAWINGS

These and other objects, features and advantages of the present invention will become apparent from the following detailed description of illustrative embodiments thereof, which may be to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computer environment according to at least one embodiment;

FIG. 2 provides an operational flowchart for an Augmented Intelligence Reality data management system, according to one embodiment;

FIG. 3 provides a block diagram illustrating an example where multiple databases and reports are merged to create a BI table, according to one embodiment;

FIG. 4 provides a block diagram illustrating ABIRD framework, according to one embodiment;

FIG. 5 provides a flow chart illustration of ABIRD framework as per embodiment of FIG. 4; and

FIG. 6 provides a more detailed illustration of concepts provided in FIGS. 2 and 5.

### DETAILED DESCRIPTION

Detailed embodiments of the claimed structures and methods may be disclosed herein; however, it can be understood that the disclosed embodiments may be merely illustrative of the claimed structures and methods that may be embodied in various forms. This invention may, however, be embodied in many different forms and should not be construed as limited to the exemplary embodiments set forth herein. Rather, these exemplary embodiments may be provided so that this disclosure will be thorough and complete and will fully convey the scope of this invention to those skilled in the art. In the description, details of well-known features and techniques may be omitted to avoid unnecessarily obscuring the presented embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

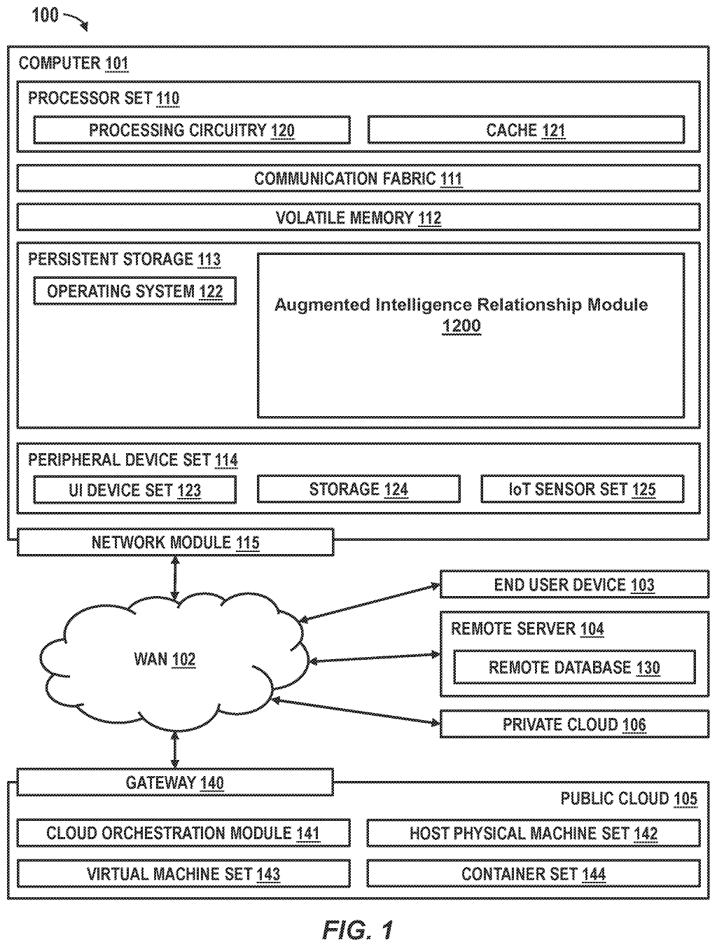

FIG. 1 provides a block diagram of a computing environment 100. The computing environment 100 contains an example of an environment for the execution of at least some of the computer code involved in performing the inventive methods, such as code change differentiator which is capable of providing an Augmented Intelligence Relationship module (1200). In addition to this block 1200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 1200, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 of FIG. 1 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 1200 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and rewriting of data. Some familiar forms of persistent storage include magnetic disks and solid state storage devices. Operating system 122 may take several forms, such as various known proprietary operating systems or open source Portable Operating System Interface type operating systems that employ a kernel. The code included in block 1200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Embodiments of the present invention disclose a method, computer system, and a computer program product for a process to establish an Augmented Business Intelligence Relationship Display (ABIRD) for managing and retrieving dynamic data changes. As mentioned earlier, business intelligence comprises strategies and technologies used by enterprises for data analysis. It may be important to have a Business intelligence (BI) dashboard with multiple reports connecting to one or more databases. It may be very difficult, however, to build relational reports and associate them especially when it can be difficult to know and retrieve the origin or source data behind each piece of information. Currently, there are no ways to view related supported source data in a specific data entry manner such as in a business information table. Unfortunately, many BI providers require administrators to transition the data links along with the content including any metadata conflict. Models containing the data source string can change from a BI tenant to other depending on network, database location and path and other data properties causing the ambiguity in identifying data base member unique name identification and dependent metadata.

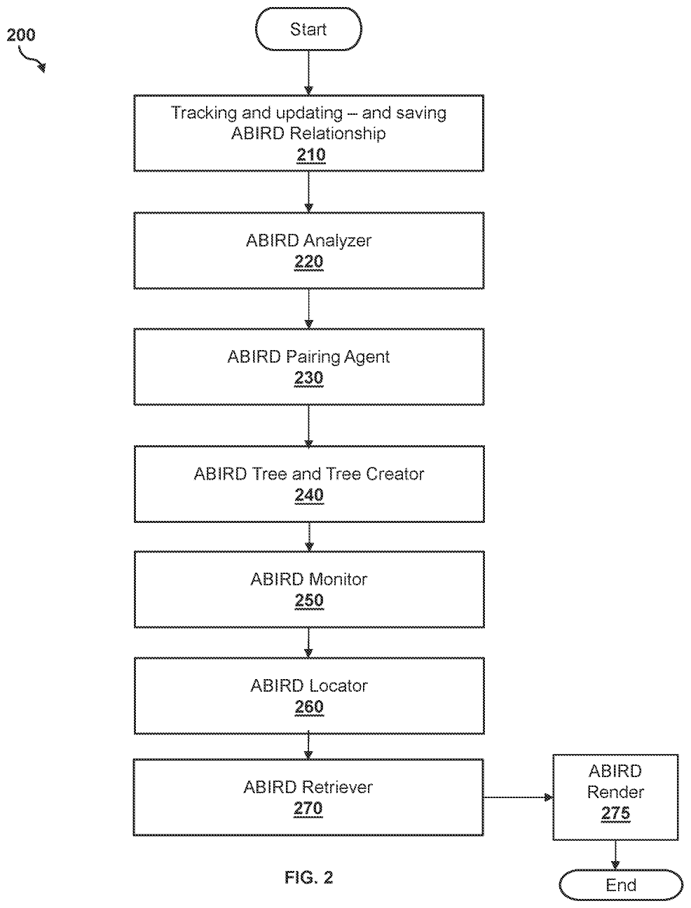

FIG. 2 provides a flowchart depiction of one embodiment showing a process 200 to provide data management using an Augmented Business Intelligence Relationship Display (hereinafter ABIRD). The process can also manage and retrieve dynamic data changes in real time. The process 200 will address the shortcomings of the prior art by providing a way to show and build a relationship between specific data entries, for example in a business information (BI) table (associating them with origins or sources of a data in an original database). In addition, hyper linked saved data (metadata) and other components and data sources may be used to show and establish relationships between any specific piece of data entry in a BI table (as supported by resource data). Having such a process will not only enhance user experience on a BI reporting platform, but it also bridges the database source and target portals (augmenting relationship between the database source and target portals).

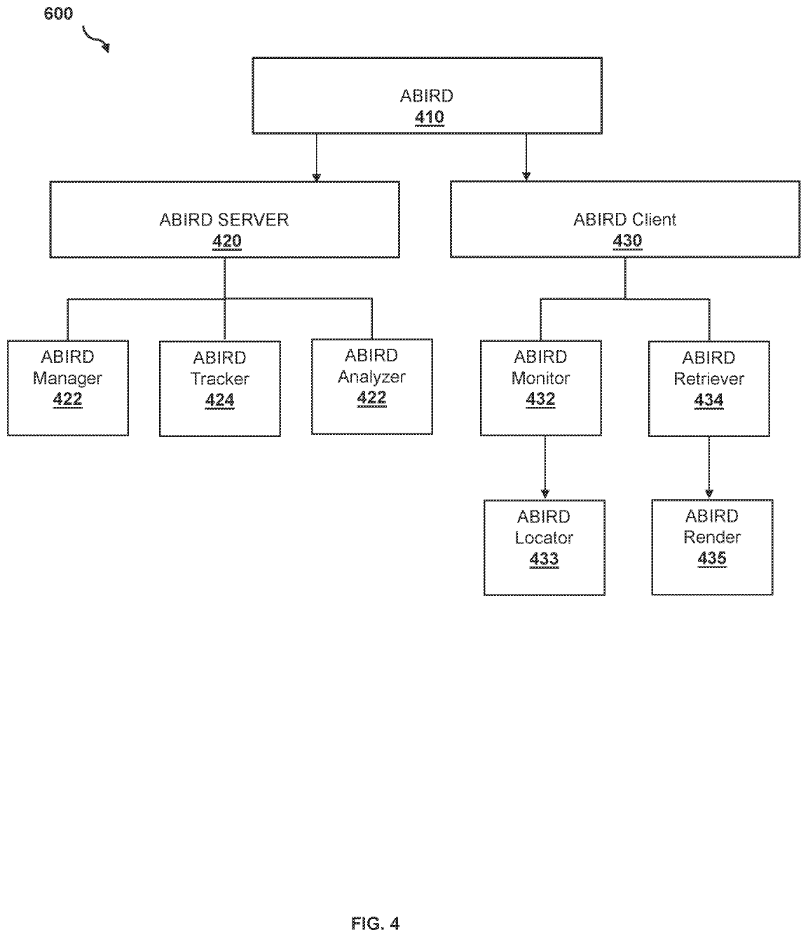

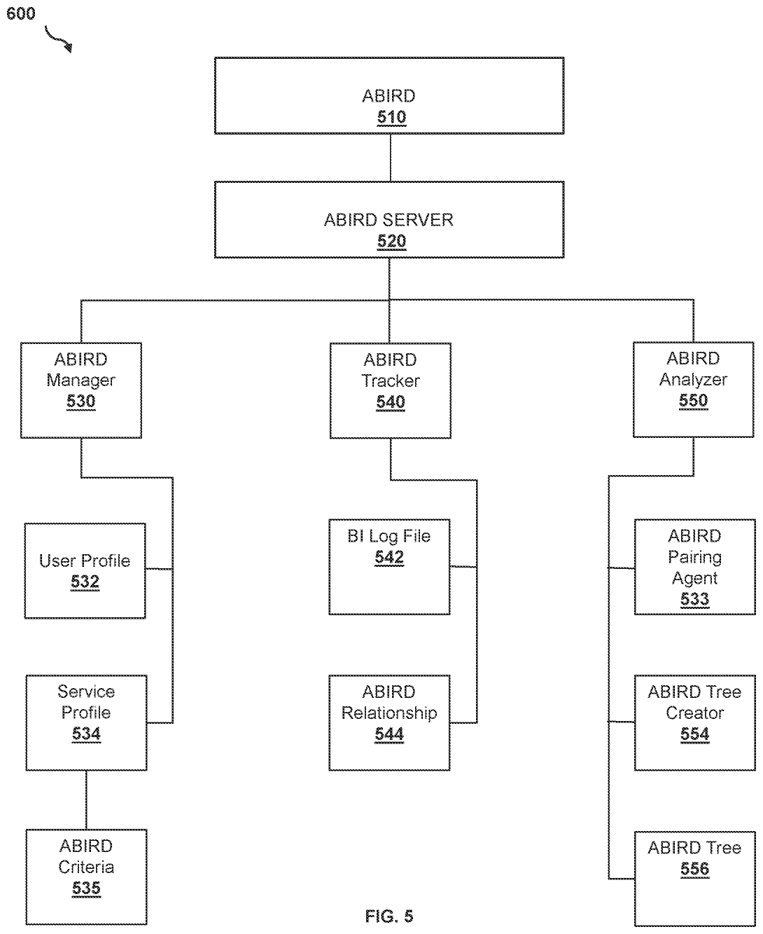

FIGS. 4 and 5 provide the framework of the ABIRD that reflect the embodiment of FIG. 2. It may be helpful to discuss these figures in conjunction with FIG. 2, as applicable, to provide an ease of understanding. The framework of ABIRD as shown in FIG. 4 as 410, includes an ABIRD Server 420 and an ABIRD Client 430. FIG. 5 reflects a more detailed view of the ABIRD Server 420. In addition, a user interface may be defined for configuring the services (such as by an ABIRD Manager 422). In FIG. 2, Steps 210-240 also provide similar framework related options.

In Step 210, the process commences with building and tracking a Business Intelligence table (hereinafter BI table). Subsequent to the creation process, the BI table may be updated (synchronized) with data provided in a management platform. The tracked and updated data may be subsequently saved into a log file or similar storage file as can be appreciated by those skilled in the art. Additionally, a framework may be to allow for support of ABIRD process. In FIG. 4, the ABIRD framework 410 includes an ABIRD Server 420 and an ABIRD Client 430. In addition, a user interface may be defined for configuring the service such as by an ABIRD Manager 422. In addition, in FIG. 5, the ABIRD Manager itself can provide more ABIRD Criteria specific functions 535 by providing a User Profile 532 and a Service Profile 534. The Service profile 534 can have further ABIRD criteria such as deep levels of the ABIRD Tree, Authentication rules and the like. The User Profile 532 may include a variety of things such as the user personal preference and settings (also more sophisticated options such as Avatar image, retrieving style, 2D/3D renderings etc.).

Referring back to FIG. 2, in Step 220, the tracked file (log) may be analyzed file (by ABIRD Analyzer 422 in FIG. 4 or as shown as 550 in FIG. 5) to determine each query processed (e.g., updated/created) as BI entry and to correlate the source information.

In Step 230, the BI entry may be paired and associated with the source data (correlated source information). This may be reflected in FIG. 5, as part of the Analyzer 550 but as reflected by ABIRD Pairing agent 533.

In Step 240, a retrievable tree may be created which may include all paired BI entries and associated source data. This may be reflected in FIG. 5 as part of the ABIRD Analyzer 550 as reflected by the ABIRD Tree Creator 554 (and ABIRD Tree later at 556).

Steps 250-270 provide real time services. Most of these services will be connected to ABIRD Client 430 in FIG. 4. For example, in one embodiment, in Step 250 the ABIRD can monitor the process (ABIRD 432 in FIG. 4). In one embodiment, the monitoring can use an eye tracking algorithm to track user eye gazing point on BI table through an augmented reality device to provide this function. Other similar functions can be provided as can be appreciated to those skilled in the art.

Eye tracking is the process of tracking the movement of the eyes to know exactly where a person is looking and for how long. Eye tracking systems measure the eye position, movement, and pupil size at a specific time to detect areas in which the user has an interest. As can be appreciated by those skilled in the art, there may be rapid developments in this area and there are many alternate ways to provide for eye tracking. Some eye tracking systems use software algorithms for pupil detection, image processing, data filtering, and the recording of eye movement by means of a fixation point, fixation duration, and saccades. Artificial intelligence (AI) may also be used to train one or more machine language (ML) engines using machine language modeling. AI may apply several other algorithms and techniques such as deep learning to solve actual problems and smartly execute tasks.

In some embodiments, computing capabilities allow machine learning (ML) algorithms to be integrated with eye tracking devices and add learning functionalities from captured data to generate smarter eye tracking devices. A large variety of hardware and software approaches have been implemented to achieve this. In a few embodiments, eyewear technologies having head-wear, special screens or glasses are used to further provide for better results. For example,” eye tracking glasses may be used to collect and analyze real-world eye tracking data using glasses and allow for advanced analysis using tools such as heatmaps, gaze replays, and areas of interest (AOI) to generate certain output metrics such as the time to first fixation and time spent. These technologies may even provide automated gaze-mapping from dynamic environments to static scenes for a simpler aggregation and analysis. Head gear or glasses are not always necessary and a regular laptop or even a mobile device can be used as well, as can be appreciated by those skilled in the art. For example, many mobile devices have multiple cameras, a front facing camera and a back-facing camera, among many other cameras may be included in mobile devices. In one scenario, a front facing camera may be looking at the image target, while a back-facing camera may point to the user operating the mobile device. In this example, the back-facing camera can capture images of the user's eyes, which can be used to determine a location on the display screen that is the current object under the user's gaze. This may then be used to evaluate a user's interest in an image on the display screen.

In Step 260, using the monitoring step, the ABIRD can locate one or more desired entries in the table. For example, an ABIRD locator (shown as 433 in FIG. 4) can locate a BI entry which may be gazed on the BI Table using the previous scenario.

In Step 270, the located BI entry can be retrieved. In one embodiment, an ABIRD tree (previously created) can be retrieved with the located BI entry and a paired relationship can be established. Finally, in the final Step 275, the rendering will become possible. In this step, the rendering will be of the branch of the retrieved tree related to the determined BI entry on the screen of the augmented reality device. The ABIRD Retriever and ABIRD Render are shown in FIGS. 4 as 434 and 435 respectively.

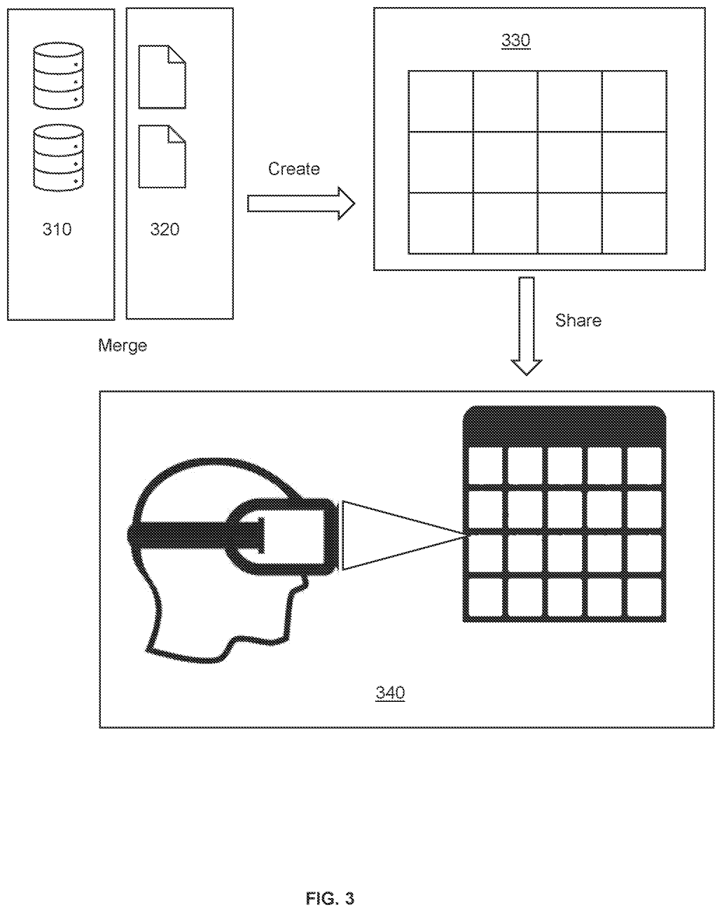

FIG. 3 provides a block diagram of an example where multiple databases 310 and multiple reports 320 may be merged to create a New BI table (data chart) 330 which may be then shared to be viewed by a user (340).

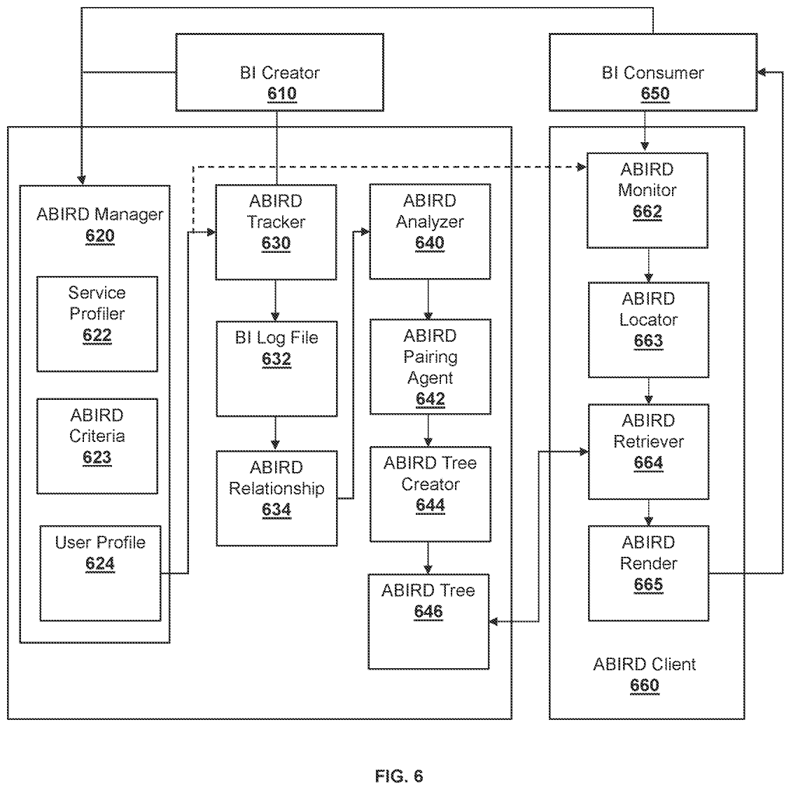

FIG. 6 is a block diagram illustrating another flow arrangement as per embodiments of FIGS. 2-5. As can be seen the BI Creator 610 and BI Consumer 650 are connected to one another but provide different functions. The BI Creator 610 includes the ABIRD Manager 620, ABIRD Tracker 630 and ABIRD Analyzer 640. As discussed earlier, ABIRD Manager 620 in turn provides Service 622 and User profiles 624 and handles ABIRD Criteria 623. ABIRD Manager may be in data communication with both the BI Consumer 650 and the ABIRD Tracker 630.

ABIRD Manager 620 provides output to ABIRD Tracker 630 that also provides the BI log file 632 and ABIRD Relationship 634 and the output is provided to the ABIRD Analyzer 640 which provides ABIRD Pairing 642, ABIRD Tree Creator 644 and ABIRD Tree 646.

ABIRD Tree block 646 may be in communicator for the ABIRD Retriever 664. ABIRD Retriever 664, ABIRD Monitor 662, ABIRD Locator 663 and ABIRD Renderer 665 may be a part of the ABIRD Client 660 as part of the BI Consumer as was discussed earlier.

To provide a better understanding an example can be provided. In this scenario, a system may suggest compatible data sources for single or a set of dashboard or reports by analyzing corresponding relationship representation. Built-in eye gazing detection tools in BI dashboard viewing devices or wearables are compatible. The system may be configurable for each user profile gazing threshold to activate the feature. In addition, a specific data cell intersection or a visualization point is linked to the source tables. In this scenario, the system may be configurable to integrate more than one gazing points and correlate more than one point of interest. Optionally, the system may be enabled to offer the user an on-screen media display of the detected database path through context menu or interface setting (mouse/keyboard) action. The system may also have a dynamic relationship mapping mechanism that sits between relationship consumers like dashboard/reports and relationship providers like modelling service and data access components. The relationship representation between report and data source does not need to be exactly the same. They just need to be compatible. The mapping system perform translation dynamically. This will avoid updating relationship definition in a report or dashboard. In one embodiment, the system may also provide capability assessment for data sources. For a report or dashboard, the system could indicate what level of information the report can produce from each compatible data sources. This may allow user to make choice based on business needs. For example, a report could run against two data sources, however, one may contain history data only, another has forecast or planned data only. Data access authentication is based on user accessing the system and secured data will be anonymized.

The descriptions of the various embodiments of the present invention have been presented for purposes of illustration but may be not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for managing and retrieving data dynamically, comprising:
creating a business information (BI) table from data obtained from a plurality of databases and a plurality of reports;
synchronizing said BI table with other data and processes provided in a management platform;
determining a user interface for a user to access said BI table having a plurality of entries, wherein said user interface has a set of rules and at least one criterion for user access;
monitoring said management platform for updates and synchronizing said BI table concurrently to include said updates;
storing all updates to said BI table and any process or query that caused said update to said management platform in a log file;
analyzing said log file to determine relationship of each of a plurality of queries processed as a BI entry into said BI table;
pairing said BI entries after said analysis and determination of relationship in said BI table with one or more associated source data;
creating a retrievable tree from all paired BI entries and associated source data;
providing said BI table to said user and monitoring a user's eye movement and a gaze to determine when said user gazes at a point on said BI table; and
using said point, retrieving a corresponding BI entry and said associated paired to be provided to said user for further viewing.

2. The method of claim 1, wherein said BI table is provided on an augmented reality device having said management platform supports an augmented business intelligence reality display (ABIRD) and a service.

3. The method of claim 2, wherein a display associated with said augmented reality device monitors said user's eye movement and gaze to determine said eye gazing point.

4. The method of claim 3, wherein an augmented reality tree BI tree (ABIRD tree) is created to pair all paired BI entries with said associated source data.

5. The method of claim 4, further comprising:
locating a BI entry after determination of said gazing point;
retrieving an augmented reality tree and determining a BI located entry and an associated paired relationship source data; and
rendering a branch of said ABIRD retrieved tree related to said determined BI located entry on a screen associated with said augmented reality device.

6. The method of claim 5, wherein said user has a profile that includes user personal preferences and settings used for rendering information to said user via a display associated with said augmented reality device.

7. The method of claim 5, claim rendering is provided using the ABIRD display.

8. A computer system for managing and retrieving data dynamically, comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is enabled to perform the steps:
creating a business information (BI) table from data obtained from a plurality of databases and a plurality of reports;
synchronizing said BI table with other data and processes provided in a management platform;
determining a user interface for a user to access said BI table having a plurality of entries, wherein said user interface has a set of rules and at least one criterion for user access;
monitoring said management platform for updates and synchronizing said BI table concurrently to include said updates;
analyzing said log file to determine relationship of each of a plurality of queries processed as a BI entry into said BI table;
pairing said BI entries after said analysis and determination of relationship in said BI table with one or more associated source data;
creating a retrievable tree from all paired BI entries and associated source data;
providing said BI table to said user and monitoring a user's eye movement and gaze to determine when said user gazes at a point on said BI table; and
using said point, retrieving a corresponding BI entry and said associated paired to be provided to said user for further viewing.

9. The computer system of claim 8, wherein said BI table is provided on an augmented reality device having said management platform supports an augmented business intelligence reality display (ABIRD) and a service.

10. The computer system of claim 9, wherein a display associated with said augmented reality device monitors said user's eye movement and gaze to determine said eye gazing point.

11. The computer system of claim 10, wherein an augmented reality tree BI tree (ABIRD tree) is created to pair all paired BI entries with said associated source data.

12. The computer system of claim 11, further comprising:
locating a BI entry after determination of said gazing point;
retrieving said augmented reality tree and determining a BI located entry and an associated paired relationship source data; and
rendering a branch of said ABIRD retrieved tree related to said determined BI located entry on a screen associated with said augmented reality device.

13. The computer system of claim 12, wherein said user has a profile that includes user personal preferences and settings used for rendering information to said user via a display associated with said augmented reality device.

14. The computer system of claim 12, wherein rendering is provided using the ABIRD display.

15. A computer program product for managing and retrieving data dynamically, comprising:
one or more computer-readable storage medium and program instructions stored on at least one of the one or more tangible storage medium, the program instructions executable by a processor, the program instructions comprising:
creating a business information (BI) table from data obtained from a plurality of databases and a plurality of reports;
synchronizing said BI table with other data and processes provided in a management platform;
determining a user interface for a user to access said BI table having a plurality of entries, wherein said user interface has a set of rules and at least one criterion for user access;
monitoring said management platform for updates and synchronizing said BI table concurrently to include said updates;
analyzing said log file to determine relationship of each of a plurality of queries processed as a BI entry into said BI table;
pairing said BI entries after said analysis and determination of relationship in said BI table with one or more associated source data;
creating a retrievable tree from all paired BI entries and associated source data;
providing said BI table to said user and monitoring a user's eye movement and gaze to determine when said user gazes at a point on said BI table; and
using said point, retrieving a corresponding BI entry and said associated paired to be provided to said user for further viewing.

16. The computer program product of claim 15, wherein said BI table is provided on an augmented reality device having said management platform supports an augmented business intelligence reality display (ABIRD) and a service.

17. The computer program product of claim 16, wherein a display associated with said augmented reality device monitors said user's eye movement and gaze to determine said eye gazing point.

18. The computer program product of claim 17, wherein an augmented reality tree BI tree (ABIRD tree) is created to pair all paired BI entries with said associated source data.

19. The computer program product of claim 18, further comprising:
locating a BI entry after determination of said gazing point;
retrieving said augmented reality tree and determining a BI located entry and an associated paired relationship source data; and
rendering a branch of said ABIRD retrieved tree related to said determined BI located entry on a screen associated with said augmented reality device.

20. The computer program product of claim 19, wherein said user has a profile that includes user personal preferences and settings used for rendering information to said user via a display associated with said augmented reality device.
